(19) United States
(12) Patent Application Publication
(10) Pub. No.: US 2008/0245223 A1
(43) Pub. Date: Oct. 9, 2008

(54) Pressurizing Device

(76) Inventor: Osamu Yanagimoto, Hyogo (JP)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 10/573,940

(22) PCT Filed: Jul. 4, 2005
(86) PCT No.: PCT/JP2005/012350

§ 371 Date: Mar. 30, 2006

(30) Foreign Application Priority Data
Jul. 5, 2004 (JP) 2004-198065

(51) Int. Cl. F15B 15/00

(52) U.S. Cl. 91/436

(57) ABSTRACT

A pressurizing device to carry out checking from outside for malfunctioning of a switching mechanism and fluid leaks from seal parts of a pressure-absorbing mechanism during operation with respect to such failures, and it is possible to avoid size increase of the device and decreasing of movement speed at times of rapid movement. A third through hole extending from a second fluid compartment to outside in the axial direction is formed passing through a fixed part; a rod is slidably supported in the third through hole so as to block the third through hole; a valve member is fixed to one end of the rod and an advancing and retracting mechanism fixed to the output shaft is connected to the other end; and a first connecting hole is opened and closed by the advancing and retracting mechanism operating and advancing and retracting the valve member in the axial direction.

### PRIORITY CLAIM

This patent application is the U.S. National Phase of International Application No. PCT/JP2005/012350, having an International Filing Date of Jul. 4, 2005, which was published under International Publication No. WO2006/004095 on Jan. 12, 2006, which claims priority to Japanese Patent Application No. JP2004-198065, having a filing date of Jul. 5, 2004, the specifications of which are incorporated herein by reference in their entirety.

### FIELD OF THE INVENTION

This invention relates to a pressurizing device having both rapid movement of an output shaft and high thrust force pressurization.

### BACKGROUND OF THE INVENTION

As mechanisms for applying a thrust force for press mold pressurization or the like, there have been screw feed type pressurizing devices, in which the rotational motion of a motor is converted into straight-line motion with a screw feed mechanism, and hydraulic pressurizing devices, in which the rotational motion of a motor is converted into straight-line motion with a hydraulic pump and a hydraulic cylinder. In these pressurizing devices of related art, when an output shaft (pressurizing part) is to be moved rapidly, a step-down ratio of the drive train is set to be small, and when high thrust force pressurization is to be carried out this can be achieved by setting the step-down ratio to be large; however, to realize a pressurizing device having both rapid movement and high thrust force pressurization it has been necessary to set the step-down ratio of the drive train to be small and additionally use an expensive, high-capacity motor, and it has been impossible to avoid problems such as large cost increases and increased device size. To overcome this, the present applicants have proposed a pressurizing device with which it is possible to realize both rapid movement and high thrust force pressurization while using a motor with a small capacity by adding to a motor-driven screw feed type pressurizing device a servo mechanism that utilizes Pascal's principle.

As shown in FIG. 4, this pressurizing device has a fixed part 1; an output shaft 2 slidably supported in the fixed part 1 and having at its bottom end a pressurizing face 2a; and an input shaft 3, connected to the output shaft 2 directly or by way of a fluid, that drives the output shaft 2 up and down. A first fluid compartment A1 and a second fluid compartment A2 filled with a fluid (oil) are formed between the fixed part 1 and the output shaft 2. The first fluid compartment A1 and the second fluid compartment A2 are divided by an annular first piston 22 formed integrally with the output shaft 2 and are connected by first connecting holes 22b provided in the first piston 22. These first connecting holes 22b are closeable (see FIG. 6) by a valve member 26 slidably supported on a support member 27 (the output shaft 2) above the first piston 22. The valve member 26 is actuated by its upper end 26a being pressed by the pressure of a fluid flowing in from a third fluid compartment A3. A pressure-absorbing mechanism 4 (a piston 42 supported by a spring 43) for, when the first fluid compartment A1 is compressed with a high pressure, relieving that fluid pressure, is provided in the first fluid compartment A1. And, a third fluid compartment A3 filled with fluid is formed between the output shaft 2 and the input shaft 3. The third fluid compartment A3 is connected to the second fluid compartment A2 by second connecting hole 21d provided in the output shaft 2, and is extended and shortened by a second piston 32 formed integrally with the input shaft 3. The second connecting hole 21d is closeable (see FIG. 4, FIG. 5) by an auxiliary valve member 21e slidably supported on the support member 27. When the second connecting holes 21d are closed with the auxiliary valve member 21e, the fluid pressure acting on the upper end 26a of the valve member 26 is increased and closing of the first connecting holes 22b with the valve member 26 is made possible.

The input shaft 3 has a ball bush 33 combined with a ball screw 14 fixed to the fixed part 1 and constituting a rotational-straight movement converting mechanism, and is moved straight up and down by the ball screw 14 being rotated by a motor not shown in the drawings. A hook 35 for engaging with the output shaft 2 and directly coupling the output shaft 2 and the input shaft 3 is provided on the upper end of the input shaft 3.

When a pressurizing treatment is carried out with this pressurizing device, first, with the hook 35 engaged and the output shaft 2 and the input shaft 3 directly connected (connected so that there is no relative movement), the input shaft 3 is moved rapidly downward with the rotational-straight movement converting mechanism. By this means, the output shaft 2 is moved rapidly downward to the position shown in FIG. 5. At this time, because the first connecting holes 22b are open and fluid (oil) in the first fluid compartment A1 flows into the second fluid compartment A2, the movement of the first piston 22 (the output shaft 2) is not checked by the fluid.

Here, by the input shaft 3 being stopped, the output shaft 2 is also stopped, but because the output shaft 2 moves a little downward under the influence of inertia before it stops, as shown in FIG. 5 the hook 35 disengages and the input shaft 3 becomes free with respect to the output shaft 2. In this free state, when the ball screw 14 is rotationally driven by the motor (not shown) and the input shaft 3 is thereby moved downward, this time, as shown in FIG. 6, by the fluid pressure inside the third fluid compartment A3 compressed by the second piston 32 the valve member 26 is actuated and closes the first connecting holes 22b and then the auxiliary valve member 21e is actuated and opens the second connecting holes 21d.

Then, by the input shaft 3 being moved further downward, fluid pushed out from the third fluid compartment A3 by the second piston 32, which has a small pressurizing area, flows into the second fluid compartment A2 and pushes on the first piston, which has a large pressurizing area. By this means, the driving force of the input shaft 3 is increased in correspondence with the ratio of the pressurizing areas of the first piston 22 and the second piston 32 and transmitted to the output shaft 2. That is, a high thrust force pressurization created by a servo mechanism using Pascal's principle is produced.

### SUMMARY OF THE INVENTION

With the pressurizing device described above, although it is possible to realize both rapid movement and high thrust force pressurization while using a motor with a small capacity, there are the following problems.

Firstly, because the valve member 26, the auxiliary valve member 21e and the members slidably supporting these, which constitute a mechanism for switching between rapid movement and high thrust force pressurization, are all accommodated in the second fluid compartment A2, the second fluid compartment A2 is large and as a result the device as a whole also becomes large.

Secondly, because the valve member 26 and the auxiliary valve member 21e are covered by the fixed part and received in the second fluid compartment A2 and their operating state cannot be seen from outside, when there is a malfunction of the switching mechanism there is a risk of operation being continued without it being noticed.

Thirdly, when wear of the outer circumferential surface of the piston 42 of the pressure-absorbing mechanism 4 has progressed, a problem of fluid leaking from the first fluid compartment A1 to the inside of the pressure-absorbing mechanism 4 arises, and because the pressure-absorbing mechanism 4 is received in the fixed part 1 there is a risk of operation being continued without the leak being noticed.

Fourthly, when inspection and repair of seal parts of the switching mechanism and pressure-absorbing mechanism 4 described above are carried out, work of dismantling the device, and particularly, laborious work of removing the output shaft 2 and the input shaft 3, which are large parts, from the fixed part 1 is necessary, and in addition to this draining and charging of fluid must also be carried out, and consequently the cost burden of maintenance is large and also the device has to be stopped for a long time.

Fifthly, not only the valve member 26 but the support member 27 for slidably supporting the valve member 26 is disposed in the second fluid compartment A2, and the opening of the first connecting holes 22b at their second fluid compartment A2 ends are covered by these. Therefore, the fluid flowing into the second fluid compartment A2 from the first fluid compartment A1 is made to flow in a roundabout way as shown by the arrow X shown in FIG. 4, and the speed of movement of the output shaft 2 and the input shaft 3 during rapid movement has been substantially limited by this fluid resistance.

This invention was made in view of these problems, and aims to provide a pressurizing device with which it is possible to perform checking from outside for malfunctioning of the switching mechanism and for fluid leakages through the seal parts of the pressure-absorbing mechanism during operation and perform inspection and repair with respect to such failures easily, and with which it is possible to avoid size increase of the device and decreasing of movement speed at times of rapid movement.

The invention set forth herein provides a pressurizing device, including: a fixed part; an output shaft, inserted in the fixed part and supported slidably in its axial direction, forming a first fluid compartment and a second fluid compartment between itself and the fixed part; a first piston, formed on the output shaft and dividing the first fluid compartment and the second fluid compartment and having a first connecting hole for connecting the first fluid compartment and the second fluid compartment; a valve member capable of opening and closing the first connecting hole; an input shaft, inserted in the output shaft and supported slidably relative to and in the same axial direction as the output shaft and forming a third fluid compartment, connected to the second fluid compartment, between itself and the output shaft; and a second piston, formed on the input shaft and having a smaller pressurizing area than the first piston, for expanding and contracting the third fluid compartment along with reciprocating movement of the input shaft, capable of selectively effecting rapid movement of the output shaft by opening the first connecting hole and coupling the input shaft to the output shaft so that relative movement of the two does not occur and effecting high thrust force pressurization of the output shaft by closing the first connecting hole and allowing relative movement of the input shaft and the output shaft by releasing the connection preventing relative movement of the input shaft and the output shaft, characterized in that a third through hole extending in the axial direction from the second fluid compartment to outside is formed in the fixed part, a rod is slidably supported in the third through hole so as to block the third through hole, the valve member is fixed to one end of the rod and a motive power source mounted outside the fixed part is connected to the other end, and the first connecting hole is opened and closed by the motive power source operating and advancing and retracting the valve member in the axial direction.

The invention set forth herein provides a pressurizing device including: a fixed part; an output shaft, inserted in the fixed part and supported slidably in its axial direction, forming a first fluid compartment and a second fluid compartment between itself and the fixed part; a first piston, formed on the output shaft and dividing the first fluid compartment and the second fluid compartment and having a first connecting hole for connecting the first fluid compartment and the second fluid compartment; a valve member capable of opening and closing the first connecting hole; an input shaft, inserted in the output shaft and supported slidably relative to and in the same axial direction as the output shaft and forming a third fluid compartment, connected to the second fluid compartment, between itself and the output shaft; and a second piston, formed on the input shaft and having a smaller pressurizing area than the first piston, for expanding and contracting the third fluid compartment along with reciprocating movement of the input shaft, capable of selectively effecting rapid movement of the output shaft by opening the first connecting hole and coupling the input shaft to the output shaft so that relative movement of the two does not occur and effecting high thrust force pressurization of the output shaft by closing the first connecting hole and allowing relative movement of the input shaft and the output shaft by releasing the connection preventing relative movement of the input shaft and the output shaft, characterized in that a third through hole extending in the axial direction from the second fluid compartment to outside is formed in the fixed part, a rod is slidably supported in the third through hole so as to block the third through hole, the valve member is fixed to one of the rod and a motive power source mounted on the output shaft is connected to the other end, and the first connecting hole is opened and closed by the motive power source operating and advancing and retracting the valve member in the axial direction.

The invention set forth herein provides a pressurizing device including: a fixed part having a hollow tubular shape with a first through hole and a second through hole formed in opposite ends of it in a tube axis direction; an output shaft having a hollow tubular shape slidably supported by the first through hole and the second through hole and forming a first fluid compartment and a second fluid compartment between itself and the fixed part; a first piston formed integrally with the output shaft and dividing the first fluid compartment and the second fluid compartment and having a first connecting hole for connecting the first fluid compartment and the second fluid compartment; a valve member capable of opening and closing the first connecting hole; an input shaft, slidably supported by the output shaft and forming a third fluid compartment, connected to the second fluid compartment, between itself and the output shaft; a second piston, formed integrally with the input shaft and having a smaller pressurizing area than the first piston, for expanding and contracting the third fluid compartment along with reciprocating movement of the input shaft; and a pressure-absorbing mechanism for, when the first fluid compartment undergoes high thrust force pressurization by the first piston, relieving the fluid pressure inside the first fluid compartment, capable of selectively effecting rapid movement of the output shaft by opening the first connecting hole and moving the input shaft with the input shaft and the output shaft in a directly coupled state and effecting high thrust force pressurization of the output shaft by closing the first connecting hole and moving the input shaft with the input shaft and the output shaft in a fluidly coupled state, characterized in that a third through hole extending in the axial direction from the second fluid compartment to outside is formed passing through the fixed part, a rod is slidably supported in the third through hole so as to block the third through hole, the valve member is fixed to one of the rod and an advancing and retracting mechanism fixed to the output shaft is connected to the other end, and the first connecting hole is opened and closed by the advancing and retracting mechanism operating and advancing and retracting the valve member in the tube axis direction.

The invention set forth herein provides a pressurizing device characterized in that the pressure-absorbing mechanism has a chamber whose volume varies in correspondence with its internal pressure connected to the first fluid compartment, and this chamber is mounted outside the fixed part.

The invention set forth herein provides a pressurizing device characterized in that the chamber comprises a hollow tubular chamber case, a pressure-absorbing piston slidably supported inside the chamber case, and a measuring device for detecting a sliding distance of the pressure-absorbing piston.

The invention set forth herein provides a pressurizing device characterized in that the pressurizing area of the pressure-absorbing piston is the same as the pressurizing area of the first piston.

The invention set forth herein provides a pressurizing device characterized in that the rod is exposed so that its operating state is visible from outside.

The invention set forth herein provides a pressurizing device including: a fixed part; an output shaft, supported slidably in its axial direction by the fixed part; an input shaft, supported by the output shaft movably relative to and in the same axial direction as the output shaft, capable of moving rapidly in the axial direction and capable of being coupled to the output shaft so that relative movement does not occur; and a fluid pressure mechanism, provided between the output shaft and the input shaft, for, when the input shaft and the output shaft move relatively, increasing a thrust force of the input shaft by means of Pascal's principle and transmitting it to the output shaft, capable of effecting rapid movement of the output shaft by coupling the input shaft to the output shaft so that relative movement does not occur and moving and effecting high thrust force pressurization of the output shaft by releasing said coupling and allowing the input shaft to move relative to the output shaft, characterized in that a motive power source of a switching mechanism for switching from the rapid movement to the high thrust force pressurization is mounted outside the fixed part.

The invention set forth herein provides a pressurizing device characterized in that the motive power source is mounted on the output shaft.

With the pressurizing device set forthherein, excellent effects of the following kinds can be obtained. Because it is not necessary to provide a supporting member for slidably supporting the valve member for opening and closing the first connecting hole, the vicinity of the opening of the first connecting hole is not covered, a smooth flow of fluid from the first fluid compartment into the second fluid compartment is ensured, and a substantial fall in the movement speed of the output shaft at times of rapid movement can be avoided. And, because a motive power source for advancing and retracting the valve member is mounted outside the fixed part and only the valve member is received in the second fluid compartment, the second fluid compartment can be constructed compactly, and as a result it is possible to construct the device as a whole compactly. And, because the motive power source for advancing and retracting the valve member is mounted outside the fixed part, when a malfunction of the motive power source has occurred, the laborious incidental work of taking out the output shaft from the fixed part and removing the fluid from inside the pressurizing device is not necessary, and inspection, repair and replacement can be carried out easily.

With the pressurizing device set forthherein, excellent effects of the following kinds can be obtained. Because it is not necessary to provide a supporting member for slidably supporting the valve member for opening and closing the first connecting hole, the vicinity of the opening of the first connecting hole is not covered, a smooth flow of fluid from the first fluid compartment into the second fluid compartment is ensured, and a substantial fall in the movement speed of the output shaft at times of rapid movement can be avoided. And, because the valve member is coupled/fixed to the motive power source (the output shaft side) by way of a rod, whatever position the first piston (output shaft side) moves to, the relative positional relationship between the valve member and the first connecting hole does not change, and there is no impairment of the opening and closing of the first connecting hole by the valve member.

With a pressurizing device set forth herein, excellent effects of the following kinds can be obtained. Because it is not necessary to provide a supporting member for slidably supporting the valve member for opening and closing the first connecting hole, the vicinity of the opening of the first connecting hole is not covered, a smooth flow of fluid from the first fluid compartment into the second fluid compartment is ensured, and a substantial fall in the movement speed of the output shaft at times of rapid movement can be avoided. And, because an advancing and retracting mechanism for advancing and retracting the valve member is mounted outside the fixed part and only the valve member is received in the second fluid compartment, the second fluid compartment can be constructed compactly, and as a result it is possible to construct the device as a whole compactly. And, because the advancing and retracting mechanism for advancing and retracting the valve member is mounted outside the fixed part, when a malfunction of the advancing and retracting mechanism has occurred, the laborious incidental work of taking out the output shaft from the fixed part and removing the fluid is not necessary, and inspection, repair and replacement can be carried out easily. Because the valve member is coupled/fixed to the advancing and retracting mechanism (the output shaft side) by a rod extending in the tube axis direction, whatever position the first piston (output shaft side) moves to, the relative positional relationship between the valve member and the first connecting hole does not change, and there is no impairment of the opening and closing of the first connecting hole by the valve member.

With the pressurizing device set forth herein, excellent effects of the following kinds can be obtained. Because the chamber case of the pressure-absorbing mechanism is mounted outside the fixed part, fluid leakage through the seal parts of the pressure-absorbing mechanism can be seen easily from outside. And, maintenance work such as seal member replacement and fluid filling can be carried out easily without taking out the output shaft from the fixed part.

With the pressurizing device set forth herein, excellent effects of the following kinds can be obtained. Because changes in the movement distance of the output shaft are monitored by means of a measuring device, it is possible to detect abnormalities arising in the pressurizing device easily.

With the pressurizing device set forth herein excellent effects of the following kinds can be obtained. Because it is possible to know the movement distance of the output shaft from the measuring device, it can be used as a guide of when adjusting the operating stroke of the pressurizing device.

With the pressurizing device set forth herein, excellent effects of the following kinds can be obtained. Because the advancing and retracting operation of the rod for actuating the valve member is visible from outside, the amount of advancing and retracting movement of the valve member can be ascertained easily. Therefore, during running, it is possible to check easily from outside that a malfunction has occurred in the mechanism for switching between rapid movement and high thrust force pressurization, or not.

With a pressurizing device set forth herein, excellent effects of the following kinds can be obtained. Because the motive power source of the switching mechanism for switching between rapid movement and high thrust force pressurization is mounted outside the fixed part, when a malfunction of the motive power source has occurred, the laborious incidental work of taking out the output shaft from the fixed part and removing the fluid is not necessary, and inspection, repair and replacement can be carried out easily.

### BRIEF DESCRIPTION OF THE DRAWINGS

FIG. 1 is a sectional view of a pressurizing device according to an exemplary embodiment;

FIG. 2 is a sectional view showing a pressurizing device according to an exemplary embodiment when rapid movement of an output shaft has ended;

FIG. 3 is a sectional view showing a pressurizing device according to the exemplary embodiment when high thrust force pressurization of an output shaft has ended;

FIG. 4 is a sectional view showing a pressurizing device of related art with an output shaft in an initial state;

FIG. 5 is a sectional view showing a pressurizing device of related art when rapid movement of its output shaft has ended; and

FIG. 6 is a sectional view showing a pressurizing device of related art when high thrust force pressurization of its output shaft has ended.

### DESCRIPTION OF THE EMBODIMENTS

An exemplary embodiment of the invention will now be described with reference to the accompanying drawings.

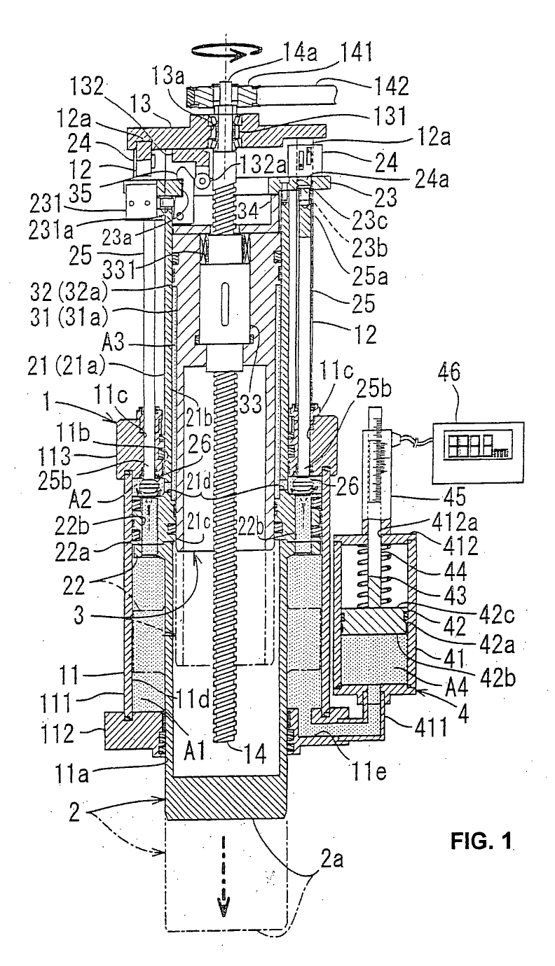

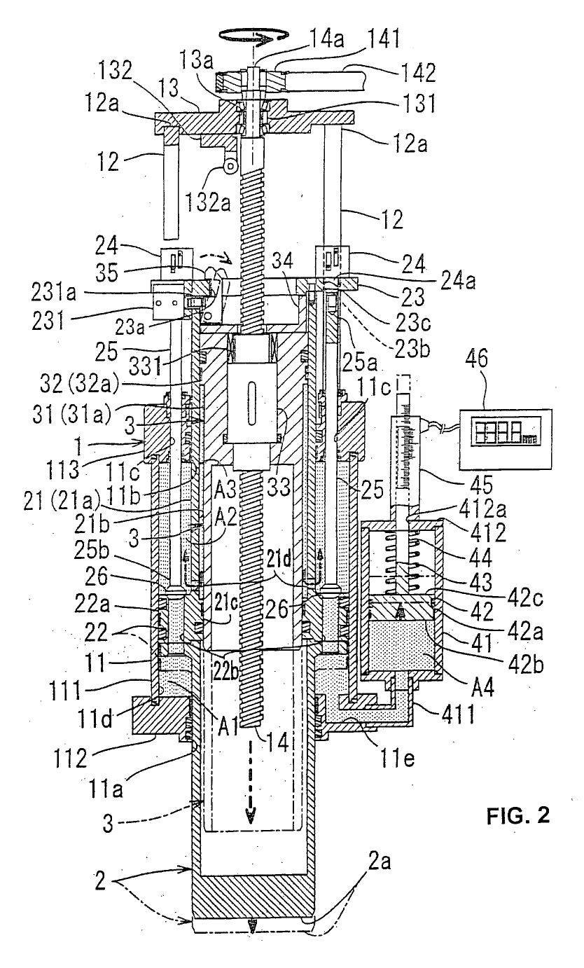

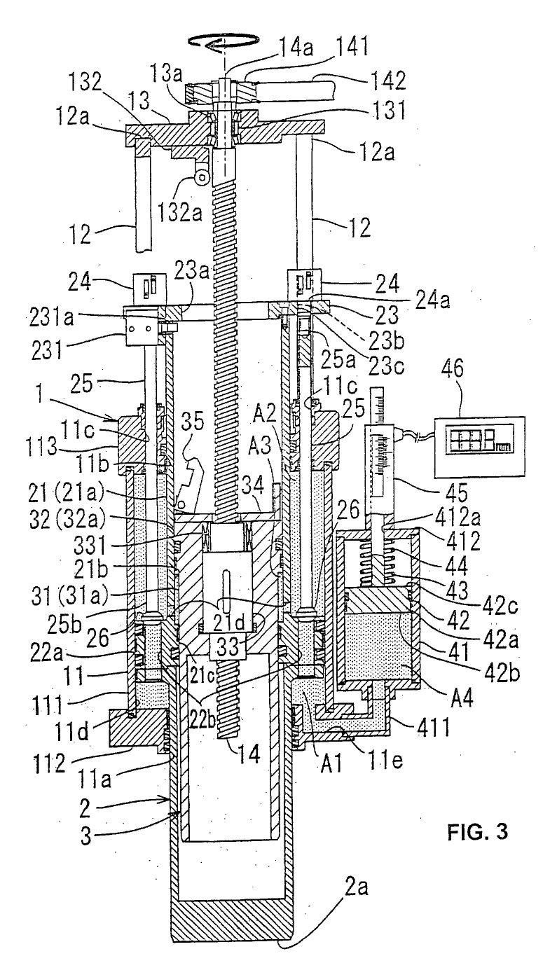

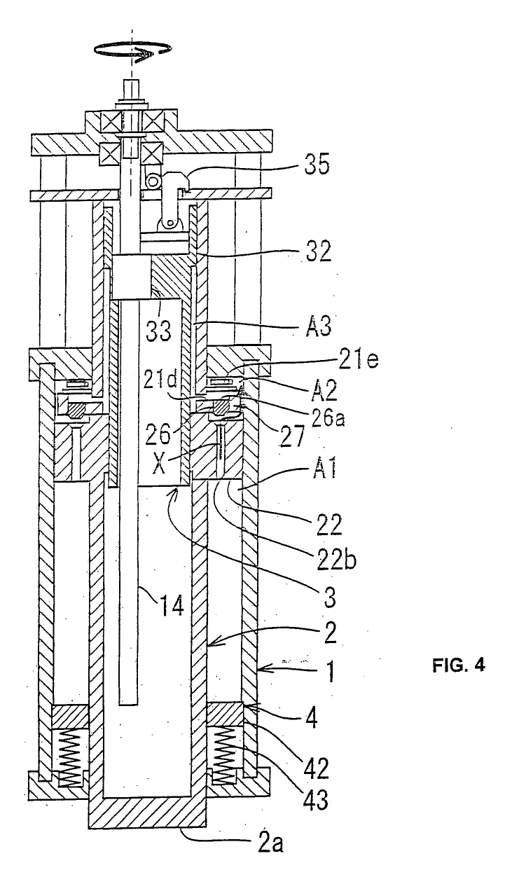

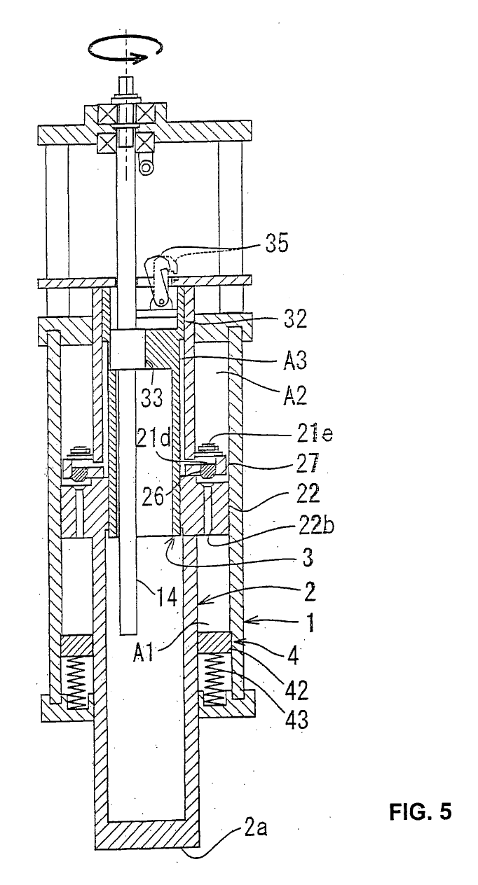

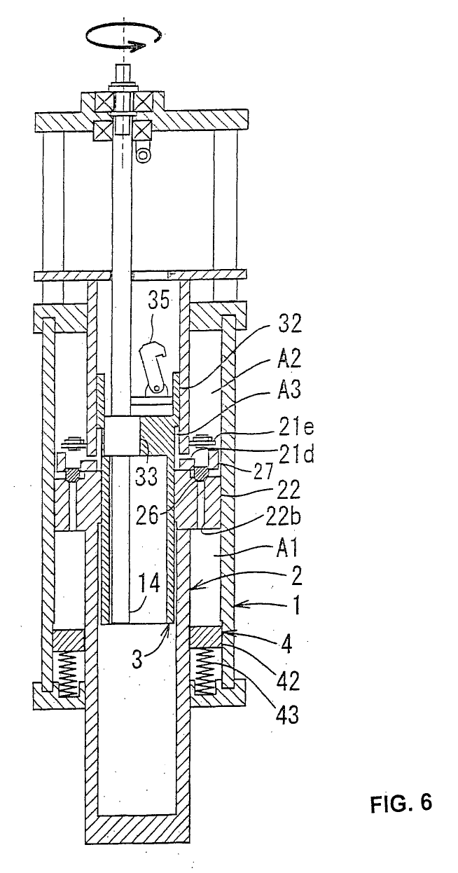

FIG. 1 through FIG. 3 are sectional views showing an example of a pressurizing device for working the invention, FIG. 1 being a view showing an output shaft 2 in an initial position, FIG. 2 a view showing rapid movement of the output shaft 2 having ended, and FIG. 3 a view showing a point at which high thrust force pressurization of the output output shaft 2 has ended. In FIG. 1 through FIG. 3, for parts the same as in the pressurizing device of related art shown in FIG. 4 through FIG. 6, the same reference numerals have been used. Although in the following, for convenience of explanation, the up-down and left-right directions in the drawings are used, the installation attitude and orientation of the pressurizing device are not limited by this, and it may be installed with an attitude and orientation different from in the following description, for example horizontally.

The pressurizing device of this exemplary embodiment, as shown in FIG. 1 through FIG. 3, consists mainly of the three members that are a fixed part 1, an output shaft 2 inserted in the fixed part 1 and supported slidably in its axial direction, and an input shaft 3 inserted in the output shaft 2 and supported slidably relative to and coaxially with the output shaft 2. The input shaft 3 is set so that it can be moved rapidly in its axial direction by a drive source (not shown) and so that it can connect directly (connect so that relative movement does not occur) to the output shaft 2. And, a fluid pressure mechanism (servo mechanism) utilizing Pascal's principle is provided between the output shaft 2 and the input shaft 3, and when relative movement occurs between the two shafts a thrust force of the input shaft 3 is increased and transmitted to the output shaft 2.

With this pressurizing device, by the input shaft 3 being directly connected to the output shaft 2 and made to move rapidly, the output shaft 2 can be made to move rapidly albeit with a low thrust force, and by the input shaft 3 being detached from the output shaft 2 and made to move relative to it, the output shaft 2 can also be pressurized with a high thrust force albeit at a low speed. That is, low thrust force rapid movement and low speed high thrust force pressurization can be carried out selectively, and by this means, until a pressurizing face 2a provided on the leading end of the output shaft 2 reaches a pressurizing position, it can be moved rapidly with a low thrust force, and after it reaches the pressurizing position it can be made to apply a high thrust force at a low speed, and it is possible to obtain a substantially equivalent function to that of a high speed, high thrust force pressurizing device using a large-capacity motor.

Although the function described above is the same as that of a pressurizing device of related art (FIG. 4 to FIG. 6), this pressurizing device has characterizing features in the mechanism for switching from rapid movement to high thrust force pressurization (cylinder units 24, drive rods 25 and valve member 26) and a pressure-absorbing mechanism 4 for, when the output shaft 2 is pressurized with a high thrust force by the fluid pressure mechanism, relieving pressure arising between the fixed part 1 and the output shaft 2. The construction and operation of this pressurizing device, including these characterizing features, will now be described in detail.

The fixed part 1 is mainly made up of a hollow, tubular fixed part proper 11; a number of guide rods 12 fixed to the fixed part proper 11 and extending in the tube axis direction (the up-down direction in the figures) of the fixed part proper 11; a plate-shaped bearing part 13 fixedly supported on distal ends 12a of the guide rods 12; and a ball screw 14 rotatably supported by the bearing part 13, and is installed on a fixed side.

The fixed part proper 11 is made up of a tube 111 circular in internal cross-section and shaped like a straight pipe and a first lid piece 112 and a second lid piece 113 attached so as to cover the end openings of the tube 111. A first through hole 11a and a second through hole 11b for slidably supporting the output shaft 2 are formed in the first lid piece 112 and the second lid piece 113. The first through hole 11a and the second through hole 11b are formed on the same axis and to a smaller diameter than the internal diameter of the tube 111, and each have a number of circular grooves cut in their inner circumferential surfaces with spaces between them in the tube axis direction. Resin seals and metal sliding members are fitted in these circular grooves. And, in the second lid piece 113, around the second through hole 11b a number of third through holes 11c are formed passing through it in the tube axis direction, and resin seals and metal sliding members are fitted in circular grooves formed in the inner circumferential surfaces of the third through holes 11c.

The guide rods 12 are in positions surrounding the second through hole 11b in the second lid piece 113 and are erected in positions off of the positions where the third through holes 11c are formed. The guide rods 12 have their distal ends 12a fixedly supporting the bearing part 13 and slidably support a sliding part 23 attached to the top of the output shaft 2 and ensure smooth forward and backward movement of the output shaft 2.

The bearing part 13 is a member having its periphery fixedly supported by the distal ends 12a of the guide rods 12; a through hole 13a is formed in its center, and a roller bearing 131 for rotatably supporting the ball screw 14 is mounted in this through hole 13a. And, a hook return mechanism 132 having a rotating roller 132a is mounted on the guide rods 12 side (the lower side in the figures) of the bearing part 13. When the output shaft 2 returns to its initial position (the position shown in FIG. 1), the rotating roller 132a of the hook return mechanism 132 makes contact with the hook 35 and pivots the hook 35 from a state in which it has tipped over inward and moved away from the output shaft 2 as shown in FIG. 3 to a state in which it has righted and engaged with the output shaft 2 as shown in FIG. 1.

The ball screw 14 is combined with a ball bush 33 provided on the input shaft 3 to constitute a rotational-straight movement converting mechanism for moving the input shaft 3 rectilinearly in its axial direction (up-down direction in the figures). The ball screw 14 has a pulley 141 fixed to a distal end 14a thereof projecting outward from the roller bearing 131 and is rotatable forward and backward by a servo motor not shown in the drawings by way of a belt 142 passing around the pulley 141. And, an encoder not shown in the drawings is provided on the distal end 14a of the ball screw 14, and on the basis of an output from that encoder the speed of the ball screw 14 can be calculated exactly.

The output shaft 2 is mainly made up of a hollow, tubular output shaft proper 21; an annular first piston 22 formed integrally with the output shaft proper 21 part-way along the output shaft proper 21 and having first connecting holes 22b formed passing through it in the tube axis direction; the plate-shaped sliding part 23, which is attached to the rear end (the upper end in the figures) of the output shaft proper 21 and has a through hole 23a formed in its center; multiple cylinder units 24 mounted on an end face (the upper face in the figures) of the sliding part 23; drive rods 25, which are rods extending in the tube axis direction with rear ends 25a connected to the cylinder units 24 and are passed through the third through holes 11c; and the valve member 26, provided on distal ends 25b of the drive rods 25, for opening and closing the first connecting holes 22b.

The output shaft proper 21 has its distal end constituting the pressurizing face 2a of when pressurizing treatment with the pressurizing device is carried out, is slidably supported in the first through hole 11a and the second through hole 11b by its outer circumferential surface 21a, and forms a first fluid compartment A1 and a second fluid compartment A2 between the outer circumferential surface 21a and the inner circumferential surface 11d of the fixed part proper 11 (the tube 111). The first fluid compartment A1 and the second fluid compartment A2 are filled with a fluid (oil), but they are sealed so that the oil does not leak out to outside the fixed part proper 11 by the seals fitted in the inner circumferential surfaces of the first through hole 11a and the second through hole 11b. Multiple second connecting holes 21d connecting the second fluid compartment A2 to a third fluid compartment A3, which will be discussed later, are formed with a predetermined spacing in the circumferential direction in the side face of the output shaft proper 21 so as to pass through from its outer circumferential surface 21a to its inner circumferential surface 21b.

The first piston 22 is formed so as to project radially outward from the outer circumferential surface 21a of the output shaft proper 21 and with its outer circumferential surface 22a following the inner circumferential surface 11d of the fixed part proper 11, and divides the first fluid compartment A1 and the second fluid compartment A2 in the tube axis direction. Seals and sliding members are fitted in the outer circumferential surface 22a of the first piston 22, and the gap between it and the inner circumferential surface 11d of the fixed part proper 11 is sealed so that oil leakage between the first fluid compartment A1 and the second fluid compartment A2 does not occur. Because the first connecting holes 22b are formed in the first piston 22 passing through it in the tube axis direction, when by relative sliding between the fixed part 1 and the output shaft 2 the first piston 22 slides up or down, the oil in the first fluid compartment A1 and the second fluid compartment A2 can move between them through the first connecting holes 22b. In the output shaft proper 21, an inner circumferential surface 21c where the first piston 22 is integrally formed is constricted to a smaller diameter than the inner circumferential surface 21b of other parts.

The sliding part 23 is a plate-shaped body with a large-diameter through hole 23a in its center, and is fixed to the rear end of the output shaft proper 21 with bolts. Besides having the ball screw 14 passing through it, the through hole 23a is used for directly coupling the output shaft 2 and the input shaft 3 (connecting them so that relative movement does not occur) by the hook 35 provided on the input shaft 3 engaging with its periphery. First insertion holes 23b are formed in the periphery of the sliding part 23 in positions corresponding to the guide rods 12, and the guide rods 12 and the first insertion holes 23b slide in correspondence with up/down movement of the output shaft 2. That is, the sliding part 23 performs the role of slidably supporting the rear end of the output shaft 2. Second insertion holes 23c for drive shafts 24a of the cylinder units 24 to pass through are formed in the periphery of the sliding part 23 separately from the first insertion holes 23b. An air cylinder 231 is mounted in a position corresponding to the hook 35 on the front face side of the sliding part 23, and when a drive shaft 231a thereof pushes the hook 35 inward to a released position (the position shown with single-dotted lines in FIG. 2), the engagement of the hook 35 and the through hole 23a is released and the output shaft 2 and the input shaft 3 can be disconnected.

The cylinder units 24 are fixed to the rear face of the sliding part 23 with their drive shafts 24a, which advance and retract electrically or otherwise, pointing downward and passing through the second insertion holes 23c. The cylinder units 24 can advance and retract the drive rods 25, which are attached to the drive shafts 24a and extend downward, to dispose the valve member 26 provided on the distal ends of the drive rods 25 in an open position (FIG. 1) where it opens the first connecting holes 22b or a closing position (FIG. 2, FIG. 3) where it closes them.

The drive rods 25 have their rear ends 25a connected to the drive shafts 24a and extend in the axial direction (sliding direction) of the output shaft 2; their axial-direction middle portions are slidably supported by the third through holes 11c, and their distal ends 25b are exposed inside the second fluid compartment A2. The drive rods 25 are slidably supported by the third through holes 11c, and the gaps between the third through holes 11c and the drive rods 25 are sealed by annular seals fitted in circular grooves provided in the inner circumferential surfaces of the third through holes 11c and thereby sealed so that oil inside the second fluid compartment A2 does not leak out. The drive rods 25 are exposed visibly from outside the device.

The valve member 26 is formed in the shape of a top and fixed to the distal ends 25b of the drive rods 25. When the drive shafts 24a have retracted upward and the valve member 26 is in its open position (FIG. 1), the first connecting holes 22b are open and oil in the first fluid compartment A1 can smoothly flow into the second fluid compartment A2 around the whole circumference of ends of the first connecting holes 22b. And when the drive shafts 24a advance downward and the valve member 26 is in its closed position (FIG. 2 or FIG. 3), by it seating on the first fluid compartment A1 side openings of the first connecting holes 22b and the first connecting holes 22b thereby being closed, oil movement between the first fluid compartment A1 and the second fluid compartment A2 can be completely checked.

The input shaft 3 is mainly made up of a cylindrical input shaft proper 31; the annular second piston 32, which is formed integrally with the input shaft proper 31 at the top of the input shaft proper 31; the ball bush 33, which is fixed in a hole passing through the input shaft proper 31 in its axial direction and combined with the ball screw 14; an L-shaped stopper 34 for establishing an axial-direction positional relationship between the output shaft 2 in its initial position and the input shaft 3; and the hook 35 for directly coupling the output shaft 2 and the input shaft 3.

The input shaft proper 31 is a tubular body inserted in the output shaft proper 21; its outer circumferential surface 31a is slidably supported on the inner circumferential surface 21c of the output shaft proper 21 (the inner circumferential surface at the position corresponding to the first piston 22), and the outer circumferential surface 32a of the second piston 32 formed integrally with it is slidably supported on the inner circumferential surface 21b of the output shaft proper 21. By this means, the input shaft 3 is made slidable with respect to the output shaft 2 in the tube axis direction and a third fluid compartment A3 is established between the outer circumferential surface 31a of the input shaft proper 31 and the inner circumferential surface 21b of the output shaft proper 21. So that the oil in the third fluid compartment A3 does not leak out between the sliding surfaces of the output shaft 2 and the input shaft 3, in the inner circumferential surface 21c of the output shaft proper 21 and the outer circumferential surface 32a of the second piston 32, seals are fitted and sliding members for ensuring a predetermined sliding characteristic are fitted.

The second piston 32, when the input shaft 3 has been moved downward relative to the output shaft 2, pressurizes-compresses the third fluid compartment A3 and pushes oil inside the third fluid compartment A3 through the second connecting holes 21d into the second fluid compartment A2. The oil pushed into the second fluid compartment A2 pushes down the first piston 22 inside the second fluid compartment A2. Here, because the second piston 32 has its pressurizing area (cross-sectional area in the direction perpendicular to the tube axis direction) set quite small compared to the first piston 22 in the second fluid compartment A2, the first piston 22 is pressurized with a force corresponding to the ratio of the pressurizing areas of the two pistons according to Pascal's principle. That is, by the first piston 22, the second piston 32, the second fluid compartment A2 and the third fluid compartment A3 being combined, the input shaft 3 and the output shaft 2 are fluidly coupled and the input force from the second piston 32 (input shaft 3) is increased in accordance with Pascal's principle and is transmitted to the first piston 22 (output shaft 2) and acts as a fluid pressure mechanism (servo mechanism).

The ball bush 33 is combined with the ball screw 14 rotatably supported on the fixed part 1 to constitute a rotational-straight movement converting mechanism for, by the ball screw 14 being rotationally driven by the servo motor not shown in the drawings, moving the input shaft 3 back and forth in the axial direction. A grease supply unit 331 for supplying grease to the ball bush 33 is mounted above the ball bush 33. So that there is no turning together of the input shaft 3, the ball bush 33 is disposed in a position offset from the center of the input shaft proper 31.

The stopper 34 is an L-shaped member fixed to the rear end of the input shaft proper 31, and in the initial position of the output shaft 2 (FIG. 1), by being abutted with the front face side of the sliding part 23 of the output shaft 2, establishes an axial-direction positional relationship of the output shaft 2 and the input shaft 3. The hook 35 is set so as to be able to engage with the through hole 23a of the sliding part 23 in this positional relationship.

The hook 35, by means of a spring not shown in the drawings, is pivotally supported so that it assumes either a position where it is righted and engages with the sliding part 23 as shown in FIG. 1 or a position where it is tipped over and disengaged from the sliding part 23 as shown in FIG. 3, and is set so that whichever of these positions it is pivoted to it will not pivot to the opposite position unless an external force acts upon it.

The pressure-absorbing mechanism 4 is a mechanism for relieving the fluid pressure in the first fluid compartment A1 compressed when the output shaft 2 is subjected to high thrust force pressurization. The pressure-absorbing mechanism 4 is made up of a chamber case 41; a chamber piston 42 for dividing the chamber case 41 in the axial direction and establishing a fourth fluid compartment A4 and sliding inside the chamber case 41 in the axial direction; a piston holding spring 43 for supporting the chamber piston 42 so that the chamber piston 42 does not slide unintentionally; a scale shaft 44 extending from the chamber piston 42 and projecting to outside the chamber case 41; a tubular scale shaft cover 45 fixed to the chamber case 41 and provided so as to allow the scale shaft 44 to pass through it; and a display 46 for detecting and digitally displaying an amount of relative movement of the scale shaft 44 and the scale shaft cover 45.

The chamber case 41 is a tubular cylinder vessel; an outside connection pipe 411 connecting the fourth fluid compartment A4 to the outside of the case is attached to the end of it where the fourth fluid compartment A4 is formed in the tube axis direction, and the outside connection pipe 411 is connected to a third connecting hole 11e, connecting with the first fluid compartment A1, formed in the second lid piece 113. Accordingly, the pressure applied to the first fluid compartment A1 is transmitted through the outside connection pipe 411 to the fourth fluid compartment A4. A removable lid piece 412 is provided on the rear face (upper face) of the chamber case 41, and by removing the lid piece 412 and taking out the chamber piston 42 it is possible to perform maintenance of the pressure-absorbing mechanism 4 and topping-up of the oil in the pressurizing device. And, a through hole 412a is formed in the lid piece 412 and the scale shaft cover 45 is mounted above this through hole 412a.

The chamber piston 42 divides the chamber case 41 into two spaces in the axial direction and establishes a fourth fluid compartment A4 filled with oil on its front face 42b side, and it has seals and sliding members in its outer circumferential surface 42a and is constructed so that fluid leakage from the fourth fluid compartment A4 into the other space on the rear face 42c side does not occur and so that it can slide smoothly inside the chamber case 41. Accordingly, when the first fluid compartment A1 is compressed and its fluid pressure is transmitted to the fourth fluid compartment A4, the chamber piston 42 smoothly withdraws upward and enlarges the volume of the fourth fluid compartment A4 and thereby absorbs the increase in fluid pressure. The pressurizing area of the chamber piston 42 is set to the same as the pressurizing area of the first piston 22, and the amount of movement of the chamber piston 42 is set to be the same as the amount of movement of the first piston 22 (output shaft 2) during high thrust force pressurization.

The piston holding spring 43 is a compression spring for, while received in the space formed on the rear face 42c side of the chamber piston 42, supporting the chamber piston 42 from the rear face 42c side. The piston holding spring 43 is set so that when with the first connecting holes 22b opened the first piston 22 moves rapidly downward and the fluid pressure of the first fluid compartment A1 (the fourth fluid compartment A4) increases slightly it holds the chamber piston 42 without moving, but when with the first connecting holes 22b closed the first piston 22 undergoes high thrust force pressurization and the fluid pressure of the first fluid compartment A1 (and the fourth fluid compartment A4) increases greatly the chamber piston 42 can withdraw upward and absorb the rise in fluid pressure.

The scale shaft 44 passes through the scale shaft cover 45, with one end fixed to the rear face 42c of the chamber piston 42. Calibrations are provided on the scale shaft 44 and the scale shaft cover 45 so that relative movement of the two can be read out, and because the amount of movement of the scale shaft 44 (chamber piston 42) and the amount of movement of the first piston 22 during high thrust force pressurization are set to be the same, the amount of movement of the output shaft 2 during high thrust force pressurization can be measured easily.

The display 46 can detect the amount of relative movement of the scale shaft 44 and the scale shaft cover 45 and digitally display this numerical value, and by this means it is possible to monitor the amount of movement of the output shaft 2 without reading the calibrations. And, an electrical signal showing the relative movement is outputted from the display 46, and by automatically monitoring it with a personal computer or the like it is possible to identify failures such as oil leakages early.

The operation of a pressurizing device constructed as described above is explained below.

FIG. 1 shows the initial state before the output shaft 2 is moved rapidly. By the sliding part 23 and the stopper 34 fixed to the respective rear ends of the output shaft 2 and the input shaft 3 being abutted, a relative positional relationship of the two shafts has been established, and by the hook 35 pivotally supported on the input shaft 3 being righted by the hook return mechanism 132 and engaging with the sliding part 23, the two shafts have been connected so that relative movement does not occur. And, the drive shafts 24a of the cylinder units 24 have retracted upward and the valve member 26 fixed to the distal ends 25b of the drive rods 25 has opened the first connecting holes 22b as shown in FIG. 1.

When from the state described above the ball screw 14 is rotated with the servo motor not shown in the drawings and the rotational-linear converting mechanism is thereby actuated, not only the input shaft 3 to which the ball bush 33 is fixed but also the output shaft 2 starts to move downward. Here, although the first fluid compartment A1 is reduced in volume by the first piston 22 formed integrally with the output shaft 2, because oil in the first fluid compartment A1 passes through the opened first connecting holes 22b and moves into the second fluid compartment A2, whose volume conversely has increased, a large fluid pressure does not act in the first fluid compartment A1 and there is no impeding of the downward movement of the output shaft 2.

Because the valve member 26 just has its rear end side fixed to the drive rods 25, the oil flowing out through the first connecting holes 22b is allowed to move smoothly into the second fluid compartment A2 without the fluid being made to flow in a roundabout way as in the pressurizing device of related art described above in which the first connecting holes are covered by a supporting member for slidably supporting the valve member. Therefore, a large resistance does not arise when the output shaft 2 (the input shaft 3) is moved, and the output shaft 2 can be moved rapidly with a servo motor of a small output capacity.

Because the drive rods 25 are connected to the sliding part 23 of the output shaft 2 side and extend in the sliding direction of the output shaft 2, they move downward the same distance as the output shaft 2 while sliding in the third through holes 11c. Therefore, the valve member 26 fixed to the distal ends 25b of the drive rods 25 also moves downward together with the first piston 22 while maintaining its positional relationship with the first connecting holes 22b.

Here, the fourth fluid compartment A4 of the pressure-absorbing mechanism 4 is connected to the first fluid compartment A1, but because as mentioned above a fluid pressure does not act in the first fluid compartment A1, the fourth fluid compartment A4 does not expand. Therefore, the scale shaft 44 also does not move at all, but the movement of the output shaft 2 can be detected on the basis of the output from the encoder not shown in the drawings provided on the distal end 14a of the ball screw 14.

The output shaft 2 stops when the driving of the servo motor stops after the pressurizing face 2a of the output shaft 2 has moved rapidly from the position shown with solid lines in FIG. 1 to a position near the pressurizing position (the position shown with singly dotted lines). After the output shaft 2 stops, switching from rapid movement to high thrust force pressurization is carried out as follows.

First, as shown in FIG. 2, by the drive shafts 24a of the cylinder units 24 forward-driving downward, the valve member 26 fixed to the distal ends 25b of the drive rods 25 seats upon the rims of the openings of the first connecting holes 22b and closes the first connecting holes 22b. Because the drive rods 25 are exposed visibly from outside and the movement accompanying operation of the cylinder units 24 can be observed from outside the device, defective closing of the valve member 26 and the like can be easily detected. For example, when the movement of the drive rods 25 is smaller than a set value (a normal value), it is likely that the valve member 26 has not seated upon the rims of the openings of the first connecting holes 22b, and conversely if the movement is above a set value, it is likely that the valve member 26 is not present on the distal ends 25b of the drive rods 25, that is, that the valve member 26 has detached.

And, by the air cylinder 231 operating along with the cylinder units 24, its drive shaft 231a is protruded and by pivoting the hook 35 to its released position releases the direct linkage of the output shaft 2 and the input shaft 3. As a result of this, the input shaft 3 becomes able to move in the axial direction relative to the output shaft 2, and fluid pushed out from the third fluid compartment A3 by relative movement of the two shafts can push the first piston 22 (the output shaft 2) downward.

When after switching has finished the ball screw 14 is rotated with the servo motor again and the rotational-linear converting mechanism is thereby operated, the input shaft 3 starts to move downward again. Because the direct linkage of the output shaft 2 and the input shaft 3 by the hook 35 has been released and the two shafts can move relatively, the volume of the third fluid compartment A3 is reduced by the second piston 32 formed integrally with the input shaft 3, and oil in the third fluid compartment A3 is pushed out through the second connecting holes 21d to the second fluid compartment A2 side. Oil pushed out to the second fluid compartment A2 side pressurizes the output shaft 2 with which the first piston 22 is integrally formed, and the second piston 32 has its pressurizing area set smaller than the first piston 22. Therefore, even with a servo motor having a small capacity, by Pascal's principle it is possible to pressurize the output shaft 2 with a high thrust force.

The volume of the first fluid compartment A1 is reduced by the amount by which the second fluid compartment A2 is expanded by the oil flowing in from the third fluid compartment A3, but oil equivalent to this volume flows into the fourth fluid compartment A4 and the pressure increase of the first fluid compartment A1 is absorbed. The movement of the output shaft 2 after it is disconnected from the input shaft 3 can be measured by means of the scale shaft 44 and the scale shaft cover 45 provided on the pressure-absorbing mechanism 4, as mentioned above, and the result is displayed on the display 46.

After the high thrust force pressurization has finished, by the valve member 26 being withdrawn by the cylinder units 24 being operated the first connecting holes 22b are opened, and also the drive shaft 231 a of the air cylinder 231 is withdrawn. After that, by the rotational-linear converting mechanism being operated and the input shaft 3 being moved upward (withdrawn), the stopper 34 is pushed upon, and the output shaft 2 is returned to the initial position shown in FIG. 1.

The pressurizing device of this exemplary embodiment, as a result of being constructed as described above, has the following characteristic points.

Firstly, with this pressurizing device, of the switching mechanism for switching between rapid movement and high thrust force pressurization, because the cylinder units 24 constituting the advancing and retracting mechanism for advancing and retracting the valve member 26 are provided outside the fixed part 1 and only the valve member 26 is received in the second fluid compartment A2, it has the characteristic point that the second fluid compartment A2 filled with oil can be constructed compactly and, as a result, the device as a whole can be constructed compactly.

Secondly, with this pressurizing device, because the cylinder units 24, which are the drive source of the switching mechanism, are mounted outside the fixed part 1, when a malfunction of the cylinder units 24 occurs, without taking the output shaft 2 out from the fixed part 1, or performing the laborious incidental work of removing the fluid from inside the pressurizing device to do that, it is possible to perform inspection, repair and replacement of the cylinder units 24 easily by disconnecting the drive shafts 24a and the drive rods 25.

Thirdly, with this pressurizing device, because it is not necessary for a member for slidably supporting the valve member 26 to be provided inside the second fluid compartment A2 as in the pressurizing device of related art described above, the vicinities of the openings of the first connecting holes 22b are not covered, smooth flow of fluid from the first fluid compartment A1 into the second fluid compartment A2 can be ensured, and it is possible to avoid a substantial fall of the movement speed of the output shaft 2 during rapid movement. Because the valve member 26 is fixed to the advancing and retracting mechanism (the output shaft 2 side) by way of the drive rods 25 (shafts) extending in the tube axis direction, whatever position the first piston 22 (output shaft side) moves to, the relative positional relationship of the valve member 26 and the first connecting holes 22b does not change, and impairment of the opening and closing of the first connecting holes 22b by the valve member 26 does not occur.

Fourthly, with this pressurizing device, because the advancing and retracting action of the drive rods 25 for actuating the valve member 26 can be seen from outside, the advancing and retracting movement of the valve member 26 can be understood easily. Therefore, during running, it is possible to check easily from outside that no malfunction has occurred in the mechanism for switching between rapid movement and high thrust force pressurization.

Fifthly, with this pressurizing device, because the chamber case 41 of the pressure-absorbing mechanism 4 is provided outside the fixed part 1, fluid leakage from the seals of the pressure-absorbing mechanism 4 can be seen easily from outside. And, just by taking off the lid 412 it is possible easily to perform maintenance work such as seal member replacement of the chamber piston 42 and fluid filling without taking out the output shaft 2 from the fixed part 1.

Sixthly, with this pressurizing device, by means of the scale shaft 44 and the scale shaft cover 45, which constitute a measuring device, it is possible to monitor changes of the movement distance of the output shaft 2, and by monitoring the output from the display 46 at all times with a personal computer it is possible to detect abnormalities occurring in the pressurizing device automatically. And, because the pressurizing force acting on the output shaft 2 can be known from a measurement result of movement distance obtained by the measuring device, without a pressure gauge being affixed to the pressurizing face 2a, setting and adjustment of the thrust force of the output shaft 2 can be carried out.

Seventhly, with this pressurizing device, because the movement distance of the output shaft 2 can be known directly from the measuring device, it can be used as a guide for adjusting the operating stroke of the output shaft.

Although some characteristic points of the exemplary embodiment have been mentioned above, the present invention is not limited to this exemplary embodiment, and various changes can of course be made without deviating from the scope of the invention.

1. A pressurizing device, comprising:
a fixed part;
an output shaft inserted in the fixed part and supported slidably in its axial direction, forming a first fluid compartment and a second fluid compartment between itself and the fixed part;
a first piston formed on the output shaft and dividing the first fluid compartment and the second fluid compartment and having a first connecting hole for connecting the first fluid compartment and the second fluid compartment;
a valve member capable of opening and closing the first connecting hole;
an input shaft inserted in the output shaft and supported slidably relative to and in the same axial direction as the output shaft and forming a third fluid compartment, connected to the second fluid compartment, between itself and the output shaft; and
a second piston formed on the input shaft and having a smaller pressurizing area than the first piston, for expanding and contracting the third fluid compartment along with reciprocating movement of the input shaft,
capable of selectively effecting rapid movement of the output shaft by opening the first connecting hole and coupling the input shaft to the output shaft so that relative movement of the two does not occur and effecting high thrust force pressurization of the output shaft by closing the first connecting hole and allowing relative movement of the input shaft and the output shaft by releasing the connection preventing relative movement of the input shaft and the output shaft,
whereby a third through hole extending in the axial direction from the second fluid compartment to outside is formed in the fixed part,
a rod is slidably supported in the third through hole so as to block the third through hole,
the valve member is fixed to one end of the rod and a motive power source mounted outside the fixed part is connected to the other end, and
the first connecting hole is opened and closed by the motive power source operating and advancing and retracting the valve member in the axial direction.

2. A pressurizing device, comprising:
a fixed part;
an output shaft inserted in the fixed part and supported slidably in its axial direction, forming a first fluid compartment and a second fluid compartment between itself and the fixed part;
a first piston formed on the output shaft and dividing the first fluid compartment and the second fluid compartment and having a first connecting hole for connecting the first fluid compartment and the second fluid compartment;
a valve member capable of opening and closing the first connecting hole;
an input shaft inserted in the output shaft and supported slidably relative to and in the same axial direction as the output shaft and forming a third fluid compartment, connected to the second fluid compartment, between itself and the output shaft; and
a second piston formed on the input shaft and having a smaller pressurizing area than the first piston, for expanding and contracting the third fluid compartment along with reciprocating movement of the input shaft,
capable of selectively effecting rapid movement of the output shaft by opening the first connecting hole and coupling the input shaft to the output shaft so that relative movement of the two does not occur and effecting high thrust force pressurization of the output shaft by closing the first connecting hole and allowing relative movement of the input shaft and the output shaft by releasing the connection preventing relative movement of the input shaft and the output shaft,
characterized in that a third through hole extending in the axial direction from the second fluid compartment to outside is formed in the fixed part,
a rod is slidably supported in the third through hole so as to block the third through hole,
the valve member is fixed to one of the rod and a motive power source mounted on the output shaft is connected to the other end, and
the first connecting hole is opened and closed by the motive power source operating and advancing and retracting the valve member in the axial direction.

3. A pressurizing device, comprising:
a fixed part having a hollow tubular shape with a first through hole and a second through hole formed in opposite ends of it in a tube axis direction;
an output shaft having a hollow tubular shape slidably supported by the first through hole and the second through hole and forming a first fluid compartment and a second fluid compartment between itself and the fixed part;
a first piston formed integrally with the output shaft and dividing the first fluid compartment and the second fluid compartment and having a first connecting hole for connecting the first fluid compartment and the second fluid compartment;
a valve member capable of opening and closing the first connecting hole;
an input shaft, slidably supported by the output shaft and forming a third fluid compartment, connected to the second fluid compartment, between itself and the output shaft;
a second piston, formed integrally with the input shaft and having a smaller pressurizing area than the first piston, for expanding and contracting the third fluid compartment along with reciprocating movement of the input shaft; and
a pressure-absorbing mechanism relieving the fluid pressure inside the first fluid compartment when the first fluid compartment undergoes high thrust force pressurization by the first piston,
and capable of selectively effecting rapid movement of the output shaft by opening the first connecting hole and moving the input shaft with the input shaft and the output shaft in a directly coupled state and effecting high thrust force pressurization of the output shaft by closing the first connecting hole and moving the input shaft with the input shaft and the output shaft in a fluidly coupled state,
a third through hole extending in the tube axis direction from the second fluid compartment to outside is formed passing through the fixed part,
a rod is slidably supported in the third through hole so as to block the third through hole,
the valve member is fixed to one of the rod and an advancing and retracting mechanism fixed to the output shaft is connected to the other end, and
the first connecting hole is opened and closed by the advancing and retracting mechanism operating and advancing and retracting the valve member in the tube axis direction.

4. The pressurizing device according to claim 3, wherein the pressure-absorbing mechanism has a chamber whose volume varies in correspondence with its internal pressure connected to the first fluid compartment, and this chamber is mounted outside the fixed part.

5. The pressurizing device according to claim 4, wherein said chamber comprises a hollow tubular chamber case, a pressure-absorbing piston slidably supported inside the chamber case, and a measuring device for detecting a sliding distance of the pressure-absorbing piston.

6. The pressurizing device according to claim 5, wherein the pressurizing area of the pressure-absorbing piston is the same as the pressurizing area of the first piston.

7. A pressurizing device according to claim 1, wherein said rod is exposed so that its operating state is visible from outside.

8. A pressurizing device, comprising:
a fixed part;
an output shaft supported slidably in its axial direction by the fixed part;
an input shaft supported by the output shaft movably relative to and in the same axial direction as the output shaft, capable of moving rapidly in the axial direction and capable of being coupled to the output shaft so that relative movement does not occur; and
a fluid pressure mechanism, provided between the output shaft and the input shaft, for, when the input shaft and the output shaft move relatively, increasing a thrust force of the input shaft by means of Pascal's principle and transmitting it to the output shaft,
capable of effecting rapid movement of the output shaft by coupling the input shaft to the output shaft so that relative movement does not occur and moving and effecting high thrust force pressurization of the output shaft by releasing said coupling and allowing the input shaft to move relative to the output shaft,
a motive power source of a switching mechanism for switching from the rapid movement to the high thrust force pressurization is mounted outside the fixed part.

9. The pressurizing device according to claim 8, wherein the motive power source is mounted on the output shaft.
